(19) United States
(12) Patent Application Publication
(10) Pub. No.: US 2008/0042993 A1
(43) Pub. Date: Feb. 21, 2008

(54) Sensor pad using light pipe input devices

(76) Inventors: Denny Jaeger, Oakland, CA (US); Andrew Lohbihler, Waterloo (CA)

Correspondence Address: ZIMMERMAN & CRONEN, LLP, 1330 BROADWAY, SUITE 710, OAKLAND, CA, 94612-2506, US

(21) Appl. No.: 11/893,492

(22) Filed: Aug. 15, 2007

Related U.S. Application Data
(60) Provisional application No. 60/838,022, filed on Aug. 15, 2006.
(60) Provisional application No. 60/879,740, filed on Jan. 10, 2007.

(51) Int. Cl. G06F 3/041

(52) U.S. Cl. 345/173

(57) ABSTRACT

A sensor pad input system for use with an electronic display screen includes a transparent sensor pad overlaying the display, and at least one tactile input device removably secured to the sensor pad. Each input device emits an IR beam transmitted by the sensor pad to an IR sensor at the edge of the sensor pad. Each input device emits a unique PN code which enables identification of the device and detection of the device setting and changes in the setting. Each input device includes a light receptor directed toward the display screen to derive location data therefrom. Input devices include knob, fader, trackball, and joystick embodiments.

### CROSS-REFERENCE TO RELATED APPLICATIONS

This application claims the benefit of U.S. Provisional Application Ser. No. 60/838,022, filed Aug. 15, 2006, and Ser. No. 60/879,740, filed Jan. 10, 2007.

### FEDERALLY SPONSORED RESEARCH

Not applicable.

### SEQUENCE LISTING, ETC ON CD

Not applicable.

### BACKGROUND OF THE INVENTION

1. Field of the Invention

This invention relates to input devices that operate in conjunction with changeable electronic displays, such as computer monitors, television monitors, electronic devices such as vending machines, video recorders, voting machines, and the like.

2. Description of Related Art

In general, electronic displays may be provided with a touch-sensing device that overlays the display to accept user inputs that correspond to images portrayed by the display. The touch sensing devices may operate on principles of resistance changes, or capacitive sensing, or, more recently, optical sensing of implements or user's fingers touching the screen. The patents noted above describe touch input devices that are designed to interact with any of these forms of touch sensing arrangements to enter user inputs that change an electronic value, perform a switch function, move a displayed object or item, and the like. Applicants have designed devices for this purpose that are described in the following U.S. Pat. Nos. 7,113,175; 7,084,860; 6,700,567; 6,670,952; 6,670,952; 6,642,919; 6,642,919; 6,441,806; 6,326,956; 5,982,355; 5,977,955; 5,936,613; 5,841,428; 5,805,146; 5,805,145; 5,786,811; 5,777,603; 5,774,115; 5,712,661; 5,694,155; 5,572,239.

One ideal form of input device for use with a display screen includes a transparent sensor pad that overlays a display screen of a computer or other electronic device, permits visualization of the display output therethrough, and accepts inputs from knobs, faders, joysticks and the like to direct inputs to the electronic device or to control outputs of the electronic device. In this arrangement the input devices are designed to transmit signals that yield identification and location of the devices on the sensor pad. The technology for this input system has not been implemented in the prior art.

### BRIEF SUMMARY OF THE INVENTION

The present invention generally comprises a transparent sensor pad input system for use with a display screen of electronic devices such as a computer monitors, television monitors, electronic devices such as vending machines, video recorders, voting machines, and the like. At least one tactile input device, such as a knob, fader, joystick and the like may be removably secured to the sensor pad to enable a user to make inputs to the sensor pad, and thus to the electronic device. Each input device is arranged to emit an IR beam that is received by the sensor pad and conducted to at least one IR sensor located at the edge of the sensor pad. Each input device is designed to emit a unique PN code or the like which enables identification of the device and detection of the device setting and changes in the setting. Thus, for example, the rotational movement of a knob or the translation of a fader cap along its track may be detected and input to the electronic device that drives software icons or other items on the associated display screen. A PN code is used to allow multiple light-pipe devices to operate simultaneously on the sensor pad, otherwise data packets from multiple devices will “collide” resulting in data loss.

In addition, each input device is also provided with a light receptor that is directed to receive light through the sensor pad from the underlying display screen. The display screen may be driven to render a single moving line in each Cartesian direction, and when the light receptor of an input device receives illumination from the moving line it emits a response signal into the sensor pad that indicates it has received a light pulse from the line input. The electronic device may then calculate the XY coordinates of the input device from the respective response signals. Alternatively, the display may be driven so that each pixel or subgroup of adjacent pixels emits a coded output representing the position of said pixel or subgroups of pixels; the light receptor response signal comprises a coded signal of the pixels aligned with location at which the input device resides, along with identification data from the input device, whereby the pixel location may be associated with the respective input device. In either case a plurality of input devices may be located, and their respective outputs may be received, tracked, and input to the electronic device.

### BRIEF DESCRIPTION OF THE DRAWING

FIG. 1 is a perspective view of the sensor pad assembly of the present invention.

FIG. 2 is a cross-sectional elevation of a knob input device constructed in accordance with the present invention.

FIG. 3 is a functional block diagram of the electronic circuit of the knob input device of FIG. 2.

FIG. 4 is a graphic depiction of signals used in transmitting data from an input device through the sensor pad.

FIG. 5 is a functional block diagram of the electronic circuit for detecting the data signals from the input devices mounted on the sensor pad.

FIG. 6 is a chart depicting the routine for decoding the PN codes of input devices mounted on the sensor pad.

FIGS. 7 and 8 are a sequence of views depicting one approach for detecting the location of an input device mounted on a sensor pad.

FIGS. 9 and 10 are a schematic layout and a schematic elevation of the trackball embodiment of the invention.

FIGS. 11-13 are views of the fader cap, fader track, and fader cap on the fader track of another embodiment of the invention.

FIG. 14 is a schematic elevation of the joystick embodiment of the invention.

### DETAILED DESCRIPTION OF THE INVENTION

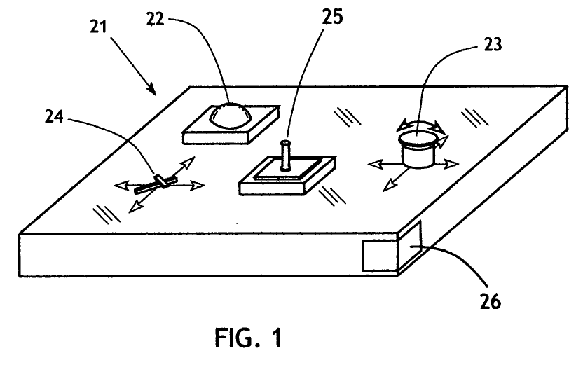

The present invention generally comprises a transparent sensor pad input system for use with a display screen of electronic devices such as a computer monitors, television monitors, electronic devices such as vending machines, video recorders, voting machines, and the like. With regard to FIG. 1, the invention provides a sensor pad 21 composed of a transparent material that easily conducts both visible and infrared (IR) light. The pad 21 may be thinner than depicted in the figure, and may have any desired shape, size, or configuration. The pad 21 is intended to be placed directly in front of an electronic display screen so that user inputs may be detected and transmitted to an electronic device that is operatively connected to the display screen, whereby the user of the invention may make inputs to the electronic device. The invention also provides at least one input device that is designed to interact with the sensor pad and direct inputs thereto. For example, the invention may provide a trackball 22, knob 23, fader 24 or joystick 25 to interact with the sensor pad 21. For this purpose, each of these devices is provided with an IR emitter that is directed toward the upper surface of the sensor pad 21. The sensor pad 21 is provided with at least one photosensor 26 secured to a peripheral edge of the pad and arranged to detect IR emissions from any of the devices 22-25. Each of the input devices emits a coded IR signal that identifies the device and transmits data regarding the setting or position change of the setting of the respective device. In all these examples the IR light emitted by the devices 22-25 is conducted through the sensor pad 21, and some of that light is scattered and received by the sensor 26, where it is detected and located, as described below.

Note that the number of sensors 26 is chosen to assure that the received IR signals have an amplitude that is above the noise of the system. However, the system does not rely on RSS (received signal strength) calculations to determine the location of the input devices, so the number and placement of sensors 26 may be less than symmetrical about the sensor pad 21.

This system is termed a light pipe, in that the sensor pad 21 acts as a transmission channel for the data signals from the input devices 22-26 to the sensor 26. All of these signals are transmitted through the single channel sensor pad to the sensor 26. Each of the input devices emits a signal into the channel that has a unique identification code combined with a data packet that describes the device setting, whether it is Cartesian XY coordinates (trackball 22 and joystick 25), angular position (knob 23), or linear displacement (fader 24).

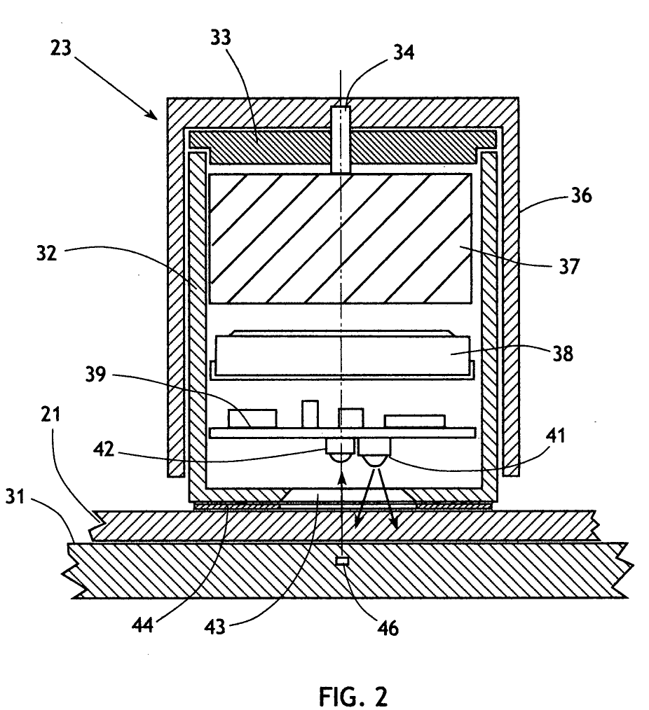

With regard to FIG. 2, the light pipe system will be described with reference to the knob input device 23, and it is noted that all the various input devices share many of the same aspects of data transmission and device detection and location, as explained below. The transparent sensor pad 21 is supported near or on the output surface of a display screen 31, and is arranged to permit light from the display screen to pass through the sensor pad. The knob 23 includes a cup-like base 32 provided with an upper opening, and a cap 33 is received in the upper opening of the base 32. A shaft 34 extends through the cap 33, and is joined to a cup-shaped, downwardly opening tubular sleeve 36, which is received concentrically about the base 32. An angular sensing device (such as a potentiometer, magnetic encoder, or the like) 37 is embedded within the base 32 and connected to the shaft 34, whereby rotation of the sleeve 36 turns the potentiometer and changes its resistance.

The knob 23 also includes a battery 38, such as a “hearing aid” battery that is cylindrical and disk-like. Also disposed within the base 32 is a circuit board 39, which supports electronic devices described below. One such device is an IR emitter 41 which is directed toward the sensor pad 21 to inject an IR signal into the light pipe signal channel of the sensor pad. In addition, the circuit board 39 supports a light receptor 42, which is also oriented toward the sensor pad 21 to receive visible light from a pixel or group of pixels 46 that is disposed in the display screen and generally aligned with the axis of the knob assembly. Note that the bottom of base 32 is provided with a transparent window 43 through which light is transmitted from emitter 41 to the sensor pad 21, and from the display screen pixel group 46 to light receptor 42. Also, the bottom surface of the base 32 is furnished with a layer of adhesive that releasably secures the knob unit to the sensor pad 21.

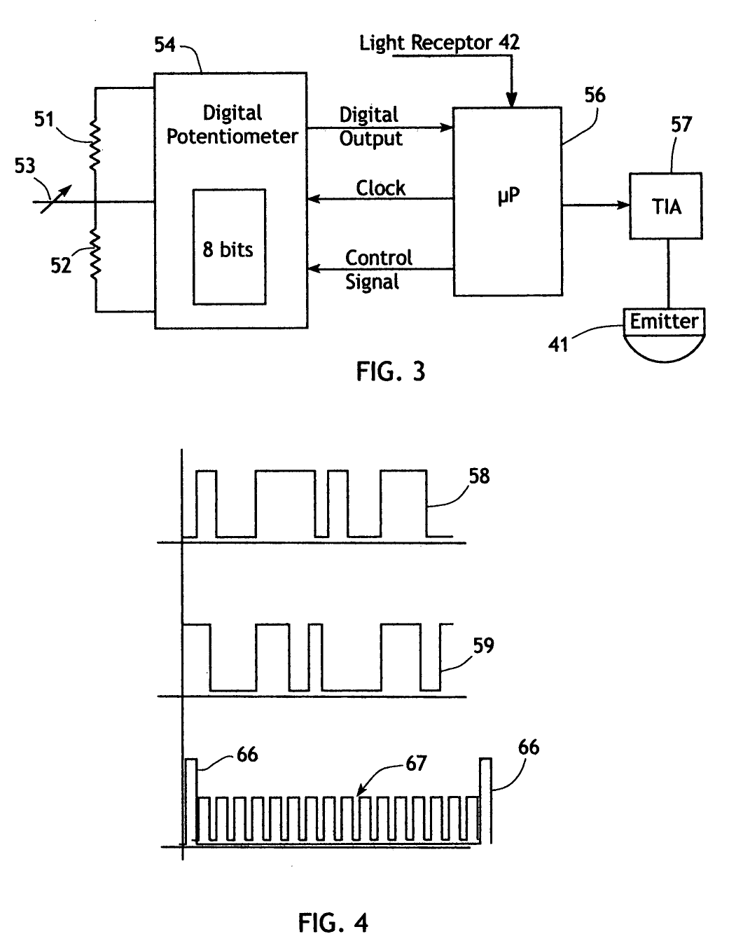

With regard to FIG. 3, the potentiometer 37 may comprise a three terminal device that is modeled as two resistors 51 and 52 connected in series with a wiper 53 interposed therebetween to vary the ratio of resistors 51 and 52. The variable voltage of wiper 53 is fed to a digital potentiometer 54, which may be an 8 bit digital device or more. The device 54 converts the analog voltage of wiper 53 to a digital signal that corresponds to the angular position of the knob sleeve 36 and potentiometer 37, and the digital signal is fed to a microprocessor 56. The microprocessor sends a clock signal to the digital potentiometer 54, and likewise a control signal to enable the digital data transfer process. The control signal activates the digital potentiometer to transmit the latest 8 bit packet representing the most up-to-date reading of the angle of the knob assembly, and that data transmission depends on the clock rate of the microprocessor.

The microprocessor 56 may be programmed to generate a PN (pseudo-noise) code sequence 58, as shown in FIG. 4, whenever a “0” (zero) is to be transmitted. To represent a “1” (one), the microprocessor generates an inverted PN code sequence 59. These code sequences are transmitted in succession, in accordance with the latest 8 bit packet from the potentiometer 54, to trans-impedance amplifier 57, which converts the PN signal to a current signal, and this current signal is connected to drive IR emitter 41 to inject the corresponding IR signal into the sensor pad 21 and thence to the sensor 26.

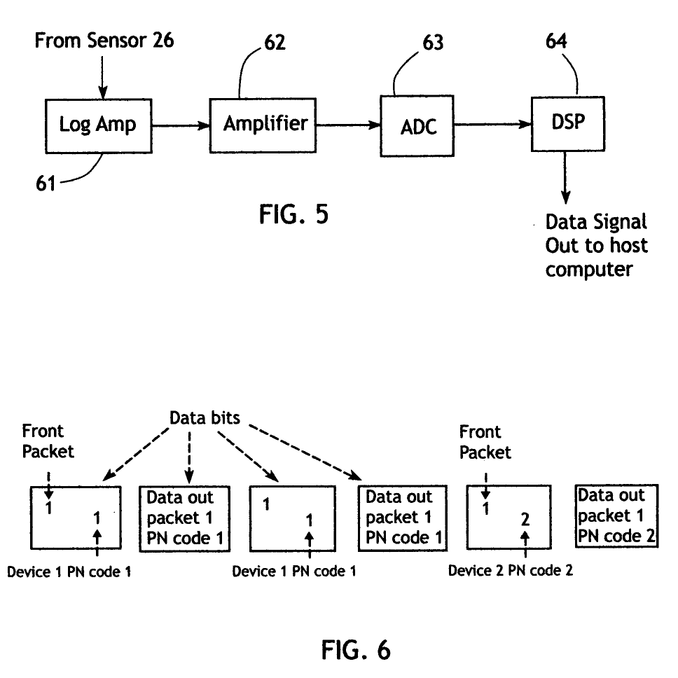

The sensor 26 produces a sensor signal that is fed to a signal detector arrangement shown in FIG. 5. The sensor signal is received by a logarithmic amplifier 61 which feeds a linear amplifier 62, and thence to an analog-digital converter 63. The digital output of the ADC 63 is fed to a digital signal processor 64. The DSP 64 is loaded with a matched filter that looks for the PN code or the inverted PN code shown in FIG. 4, and generates a data signal output that is the same as the 8 bit packet generated by the digital potentiometer 54.

Note that each of the input devices mounted on the sensor pad 21 is provided with its respective unique PN code, and the DSP 64 is loaded with all the PN codes of the devices operating on the sensor pad 21. Thus the matched filter arrangement enables the system to distinguish multiple input devices 22-25, and track each of their signals. For example, with reference to FIG. 6, the DSP 64 receives data bits from the sensor signal as packets, and the packets are compared to Device 1, PN code 1, leading to data out for packet 1, PN code 1. At the same time the packet is compared to Device 2, PN code 2 in a parallel process, leading to data out for packet 2, PN code 2. Each data packet that is successfully compared to a PN code presented in the DSP 64 leads to a zero or one in that respective devices data stream, and when eight bits are accumulated the setting of the respective device is known and transmitted. As shown in FIG. 4, each control signal 66 from microprocessor 56 may cause the digital potentiometer 54 to generate 16 chip sense signal transitions 67. The signal 67 can easily carry an eight bit data packet, allowing for a few wasted bits due to serial latencies, error coding, and the like. A typical data rate for this arrangement is on the order of 40 to 250 readings per second outputs for each input device, corresponding to latency times in the range of a few milliseconds, a rate that minimizes delays and gives the appearance of real time response to a user.

The data signal output of DSP 64 is transmitted to whatever device or circuit function is being controlled by the sensor pad assembly. Typically, the display will portray representations of the input devices 22-25, and the data signal output will cause a change in the representations of the settings of those devices in correspondence with actual physical movement of the devices by the user. These changes may be used to affect, control, or modify the functioning of the device for which the display screen 31 is a user interface. Such arrangements are known in the prior art.

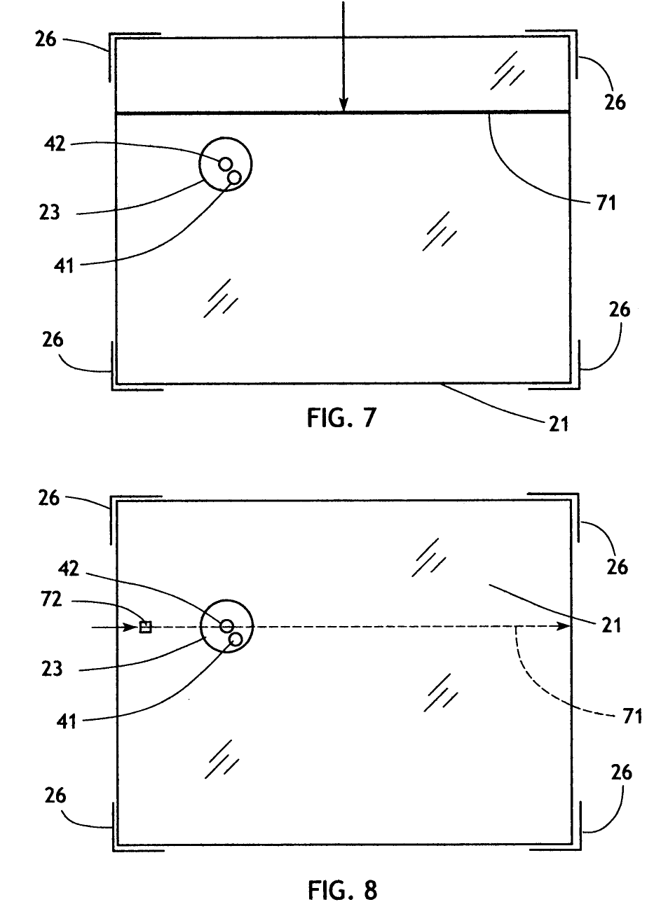

As noted previously, the PN codes programmed into the input devices described herein do not contain position data, so there is not a way to use the PN codes to determine device location on the sensor pad. Therefore the invention provides a general methodology to determine the position data of each device. With regard to FIGS. 7 and 8, a sensor pad 21 may be surveyed for device position data by briefly driving the display screen 31 to turn black, and a horizontal line of one illuminated pixel (or a small number of pixels) width. The line 71 moves across the screen, from top to bottom in a smooth sweep, until the line 71 aligns with the light receptor 42 of the device 23. When the light receptor 42 generates a signal in this location detection routine (which can be transmitted by IR emitter 42 to sensors 26), the line 71 disappears (FIG. 8) and is replaced by a pixel packet 72 (a small group of adjacent pixels (minimum of one pixel)) which is illuminated and moves horizontally across the display along the last position of line 71, aligned with the light receptor 42. When the pixel packet illuminates the light receptor 41, the signal therefrom (which can be transmitted by IR emitter 42 to sensors 26) completes the Cartesian XY data describing the position of the device 23 on the sensor pad 21. The resolution of this approach is dependent on the width of the line 71 and size of pixel group 72, as well as the angle of acceptance of the light receptor 42.

Another approach to detecting the location of each input device involves employing individual pixels or pixel packets that are driven to produce a pulse code output that is detected by light receptor 42. Each pixel or pixel group may be assigned a unique code, and that code, when detected by light receptor 42 and fed into microprocessor 56 (FIG. 4), results in a PN coded output from the device 23 through the light pipe sensor pad 21 to sensors 26, and thence to the detection scheme of FIGS. 5 and 6. The coded signal from the pixel(s) may take place at a data rate that is greater than the flicker perception rate of the human eye, whereby the encoding will not be distracting for the user. The size of the pixel group should approximate the size of the base of the input device, whereby code length and bit rate may be optimized for the device locating task.

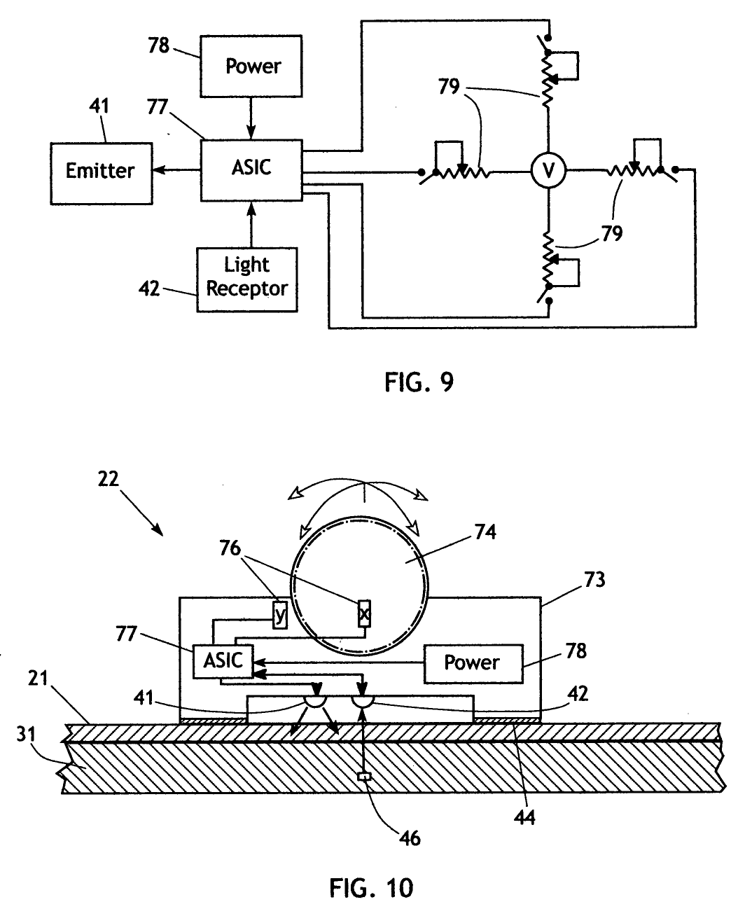

With regard to FIGS. 9 and 10, the trackball input device 22 shown in FIG. 1 is comprised of a base 73 that is releasably secured to the sensor pad 21 by an adhesive layer 44. The sensor pad 21 overlays a display screen 31, as described previously, so that inputs made to the trackball unit 22 may be detected and entered into the device that drives the display screen 31. An input ball 74 is received in a socket in the base 73, which is provided with X and Y sensors that are activated by rolling motion of the ball 74 by the user, as is known in the prior art. The XY sensor signals are fed to an ASIC 77, which is powered by a battery or other power source 78. The ASIC is connected to the IR emitter 41 and light receptor 42, both of which operate in the same manner as described with reference to the previous embodiment.

As shown in FIG. 9, the XY sensors for the trackball may comprise an orthogonal set of potentiometers 79 that respond to the respective Cartesian movement of the ball by the user. The changes in voltage of each potentiometer are fed to the ASIC 77, which combines both a microprocessor and an ADC. (Note that some microprocessors include analog inputs as a standard feature, and may also be used instead of the ASIC.) The ADC inside the ASIC receives the voltage inputs from the potentiometers 79, digitizes these signals, and feeds them to its microprocessor, which encodes the digital signals with a PN code. The IR emitter is driven by the PN code to inject the corresponding IR signal into the sensor pad 21. Thus movement of the trackball 74 by the user is detected and transmitted by the trackball device 22 within a few milliseconds to the electronic device that operates the display screen 3l, as detailed above. Likewise, the light receptor 42 generates a signal that is digitized and encoded upon command from the microprocessor within the ASIC 77, so that the location of the trackball device 22 on the sensor pad may be determined, as explained previously.

Note that in all the embodiments described herein, the functions of IR light emitter and light receptor may be served by a single semiconductor device.

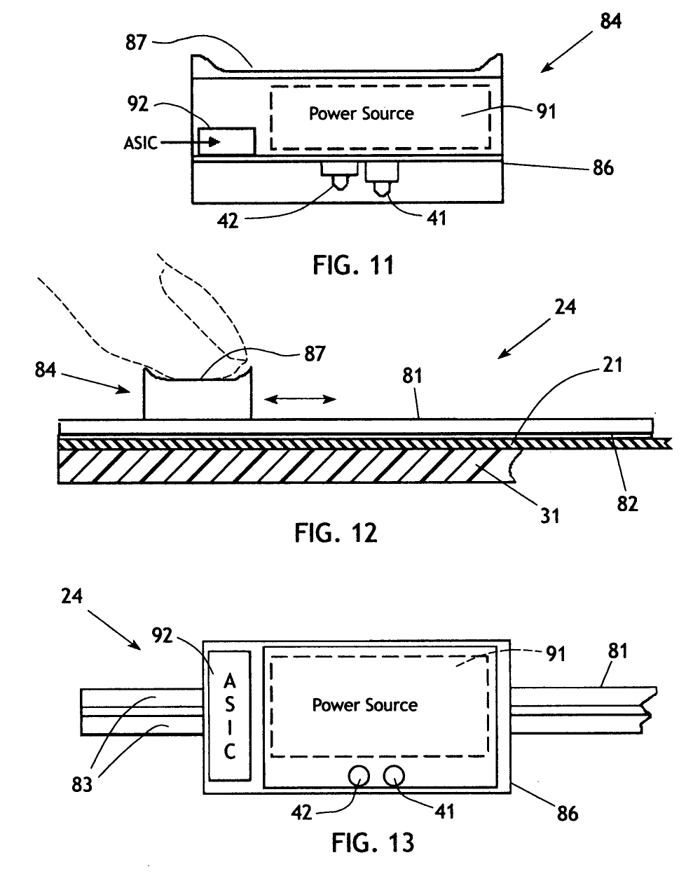

The construction of the fader input device 24 of FIG. 1 is described with reference to FIGS. 11-13. The device 24 includes a linear travel guide, or track 81 that is provided with a releasable adhesive layer 82 for removably securing the track 24 to a sensor pad 21 that overlays a display screen 31. At least two resistive traces 83 extend substantially the entire length of the track 81, as shown in FIG. 13. The traces 83 may be placed on the upper surface of the track, as shown in FIG. 13, or one or both traces may be disposed on side edges of the track. A fader cap 84 is slidably secured to the track 81 and adapted to be translated along the track by minimal fingertip pressure applied to the cap 84. The fader cap includes an outer housing 86 having an upper surface 87 sized and configured to comfortably receive a fingertip touch, as shown in FIG. 12. It is noted that the housing 86 is noticeably wider than the track 81.

Within the housing 86 there is disposed a power source 91, such as a battery, photocell, EM field pickup, or the like. An ASIC 92 is secured within the housing 86 and connected to the power source 91. An IR emitter 41 and a light receptor 42, as described previously, are supported by the housing 86 and directed downwardly therefrom to inject a coded IR signal into the sensor pad 21 and to receive light from pixels of the display screen 31 to derive positional information of the device 24 on the screen. The slidable housing 86 is provided with contact pads that electrically connect to the resistor traces 83 and detect the resistance of the traces at the position of the cap 84 along the track 81. The resistance value, which corresponds to the cap displacement along the track, may be used to determine the cap position. As in the previous embodiments, the analog resistance value is fed to the ASIC (similar to one potentiometer branch in FIG. 9), which converts the analog signal to a digital signal and encodes the digital signal with a PN code. The PN code is then used to drive the IR emitter 41 to inject the coded IR signal into the sensor pad, ultimately to be detected and decoded to derive the fader cap setting along the track 81. The light receptor 42 is also used as described previously to receive directed light or a coded pixel signal from the display screen, so that the ASIC may encode that signal and drive the IR emitter 41 to transmit the appropriately coded signal to the sensors 26.

This embodiment of the invention differs from other previous embodiments in that both the IR emitter 41 and the light receptor 42 translate with the cap assembly that is moved by the user to change the setting of the input device 24. Thus there is an opportunity to use the position sensing aspect of the invention to determine the location of the device 24 on the sensor pad, as well as to detect displacement of the position of the fader cap to derive changes in the setting of the fader cap. For example, the fader device 24 may initially be placed on the sensor pad 21 with the fader cap at the minimum setting, and the software may identify the position of the fader cap 84 on the sensor pad 21. Thereafter, the user may translate the fader cap 84 to the maximum setting position on the track 81, and the software may be directed to take another position reading. The host computer connected to the display screen and the sensor pad thus are apprised of the range of motion of the fader cap on the track, and may easily calculate or look up the fader cap setting of each fader cap position that is detected thereafter. In this arrangement there would be no need for the resistive traces 83 for generating an analog position signal, since the position detector scheme using the display screen light serves the same purpose assuming that the light-based positioning can be done in real-time.

Alternatively, the position detection function may be used to augment the resistance-derived reading of the fader cap that is transmitted by the IR emitter 41. For example, a “smart” device system may correlate the resistance-derived readings with the position-derived readings, whereby linearity, redundancy, and reproducibility may be improved.

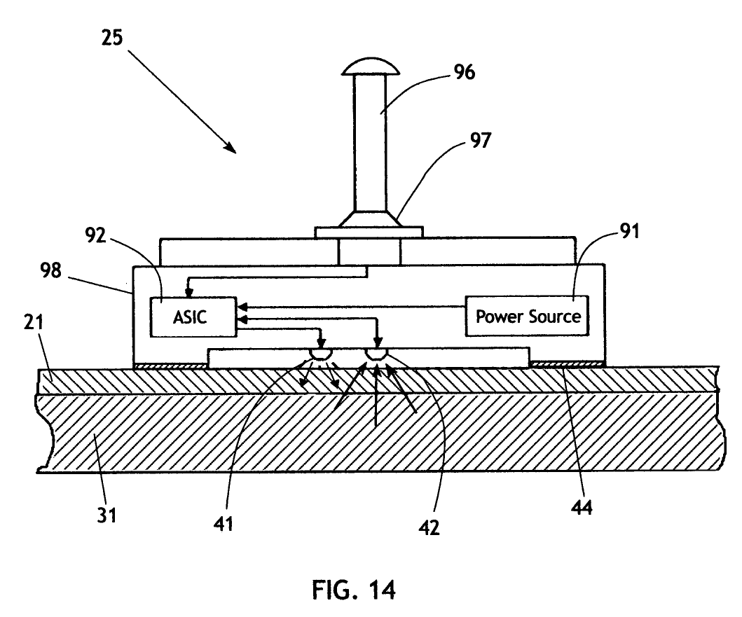

With reference to FIG. 14, the joystick embodiment 25 of the input device of the invention is comprised of a housing 98 that is secured to a sensor pad 21 that overlays a display screen 31 by a layer 44 of releasable adhesive. Extending upwardly from the housing 98 is a joystick wand 96 which is supported by a flexible mount 97. Within the housing an ASIC 92 is secured, along with a power source 91 that powers the ASIC. IR emitter 41 and light receptor 42 are directed downwardly from the housing 98 to inject a coded IR signal into the sensor pad 21, and to receive light from adjacent pixels of display 31, respectively. As in the previous embodiment of FIGS. 9 and 10, the input element (the wand 96) changes the resistance relationships of potentiometers 79 and the resulting analog XY signals are digitized by the ASIC and encoded with a PN code loaded into the ASIC. The coded signal is injected by the IR emitter 41 into the sensor pad light pipe and received by the sensors 26, resulting in the joystick physical inputs being detected and decoded and transmitted to the electronic device that is operatively associated with the display screen 31. And, as also described previously, the light receptor 42 receives illumination from pixels at the location of the device 25 on the sensor pad, and these pixels are illuminated either sequentially or driven with a pulse coded signal so that the light receptor signal is unique for the location of the device 25. After encoding by the ASIC and transmission through the sensor pad, the receptor signal is detected and decoded to yield the location of the device 25 on the sensor pad.

Thus in all the embodiments of the invention there are provided various mechanical input devices that may interact with images produced on a display screen by an electronic device. The sensor pad of the invention enables the mechanical input devices to transmit digital signals indicating their settings through the sensor pad to sensors and circuitry that identify the devices, derive readings indicating the most current settings of the devices, and transfer that information to the electronic device that is operatively associated with the display screen. Thus a user may enter changing values for variables into the electronic device, and the display may be changed accordingly, all within a time frame sufficiently small to appear to be instantaneous. Knobs, faders, trackballs, and joysticks are the most well-known input mechanisms for electronic devices, and the present invention exploits these familiar devices and adapts them for use with the display of virtually any electronic system.

The foregoing description of the preferred embodiments of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. An assembly for generating inputs to an electronic device having a changeable display, including:
a sensor pad overlaying at least a portion of said display, said sensor pad being transparent to permit visualization of the display therethrough, said sensor pad also transmitting infrared signals laterally therethrough;
a tactile input device secured to said sensor pad, said input device including a moving element for receiving a user tactile input and undergoing corresponding displacement;
said input device including signal means for generating a first signal corresponding to the position of said moving element;
infrared (IR) means for transmitting said first signal through said sensor pad;
sensor means coupled to said sensor pad to receive the IR signal and derive a second signal indicating the position of said moving element; and,
means for transmitting said second signal to said electronic device to appropriately modify the changeable display.

2. The assembly for generating inputs to an electronic device of claim 1, wherein said IR means further includes an IR emitter directed from said input device toward said signal pad, and means for driving said IR emitter to inject said first signal into said sensor pad as a coded IR signal.

3. The assembly for generating inputs to an electronic device of claim 2, wherein said coded IR signal uses a pseudo-noise (PN) code.

4. The assembly for generating inputs to an electronic device of claim 2, wherein said signal means generates an analog signal representing said position of said moving element, and further including and ADC for generating a digital position signal.

5. The assembly for generating inputs to an electronic device of claim 4, wherein said input device further includes a digital processor for receiving said digital position signal and generating a corresponding PN coded output signal.

6. The assembly for generating inputs to an electronic device of claim 5, wherein said PN coded output signal drives said IR emitter.

7. The assembly for generating inputs to an electronic device of claim 1, wherein said tactile input device comprises a unit selected from a group that includes knobs, faders, joysticks, and trackballs.

8. The assembly for generating inputs to an electronic device of claim 3, wherein said sensor means includes means for amplifying said IR signal and converting said IR signal to a digital received signal.

9. The assembly for generating inputs to an electronic device of claim 8, wherein said sensor means further includes matched filter means for detecting PN codes in said digital received signal to thus derive said second signal from said IR signal.

10. The assembly for generating inputs to an electronic device of claim 9, further including a plurality of said input devices, each having a respective unique PN code, whereby a plurality of second signals may be derived from said IR signals by said sensor means and detected simultaneously by said matched filter means.

11. The assembly for generating inputs to an electronic device of claim 1, further including means for deriving the location of said input device on said sensor pad.

12. The assembly for generating inputs to an electronic device of claim 11, wherein said means for deriving the location includes a light receptor in said input device and directed to receive illumination from a portion of said display directly adjacent to said input device.

13. The assembly for generating inputs to an electronic device of claim 12, further including means for driving said display to portray a unique identifying illumination to said light receptor.

14. The assembly for generating inputs to an electronic device of claim 13, wherein said display is subdivided into groups of pixels, and each group of pixels is driven with a unique pulse code.

15. The assembly for generating inputs to an electronic device of claim 14, wherein said light receptor receives said unique pulse code at the location of said input device and outputs a corresponding pulse coded receptor signal.

16. The assembly for generating inputs to an electronic device of claim 15, wherein said IR means also transmits said pulse coded receptor signal to said sensor means, and said means for transmitting said second signal also transmits said pulse coded receptor signal to said electronic device, whereby said input device may be portrayed at its actual location with respect to the display and said sensor pad.

17. The assembly for generating inputs to an electronic device of claim 13, wherein said unique identifying illumination comprises a narrow line scanned across the display of the electronic device to provoke a corresponding light receptor signal when said narrow line illuminates said light receptor and define one coordinate line of said location of said input device.

18. The assembly for generating inputs to an electronic device of claim 17, wherein said unique identifying illumination further includes illuminating a group of pixels sequentially across said one coordinate line of said location to provoke a second corresponding light receptor signal and define the location of said input device along said one coordinate line.

19. The assembly for generating inputs to an electronic device of claim 1, wherein said sensor means includes at least one IR sensor coupled to an edge portion of said sensor pad.

20. The assembly for generating inputs to an electronic device of claim 10, wherein said sensor pad comprises a single channel light pipe for transmitting said first signals from said plurality of input devices to said sensor means.
